(19) United States
(12) Patent Application Publication
(10) Pub. No.: US 2024/0196902 A1
(43) Pub. Date: Jun. 20, 2024

(54) ANTIMICROBIAL FORMULATIONS FOR RUBBER PRODUCTS AND METHOD OF PREPARATION

(71) Applicant: Prerna Goradia, Mumbai (IN)

(72) Inventor: Prerna Goradia, Mumbai (IN)

(21) Appl. No.: 18/591,388

(22) Filed: Feb. 29, 2024

Related U.S. Application Data
(63) Continuation of application No. PCT/IN2022/050766, filed on Aug. 29, 2022.

(30) Foreign Application Priority Data
Aug. 30, 2021 (IN) 202121039249

(51) Int. Cl. A01N 59/20; A01P 1/00; C08K 3/015

(52) U.S. Cl. CPC A01N 59/20; A01P 1/00; C08K 3/015

(57) ABSTRACT

The present invention relates to anti-microbial formulations and its application for rubber products. Particularly, the present invention relates to anti-microbial compositions incorporated as an additive, which can be effective against several bacteria, fungus and virus families. The anti-microbials are synthesized using a unique process and then added into the material of the articles during the rubber manufacturing process, so the rubber articles do not need additional surface applications such as dipping or spraying with solutions and chemicals.

### RELATED APPLICATIONS

This application claims priority under 35 U.S.C. § 120 to, and is a continuation of, co-pending International Application PCT/IN2022/050766, filed Aug. 29, 2022 and designating the US, which claims priority to IN Application 202121039249, filed Aug. 30, 2021, such IN Application also being claimed priority to under 35 U.S.C. § 119. These IN and International applications are incorporated by reference herein in their entireties.

### FIELD

The present invention broadly relates to antimicrobial formulations for rubber lattices. More particularly, the invention relates to antimicrobial formulations suitable as an additive in manufacturing latex goods, medical equipments and other shaped articles and method of preparing the same. The antimicrobial formulations, provide persistent antimicrobial activity by allowing slow release of an antimicrobial agent there from.

### BACKGROUND

Elastomeric products, made from natural and synthetic polymeric materials such as polyurethane or polychloroprene materials, rubber, vinyl or polyvinyl chloride, due to their elastomeric property have been used in various types of applications, such as medical equipments, food technology and other industrial uses. But extended usage of these elastomeric products possesses serious microbial growth contamination problems. Such as, catheters left in the urinary tract for a prolonged period or contamination in Ryles tube can lead to secondary infections which can be difficult to control.

A range of antimicrobial products are used for this purpose in the field of medical equipments, diagnosis, and sanitation and food technology, for prevention of contamination by bacteria, viruses and fungi of varied types. Amongst them, antimicrobial agents, having potent microbicidal activity against a broad spectrum of microorganisms and low toxicity to the human body, comprise one important class of available microbicidal disinfectants.

Considering these factors, there is the need of potent non-toxic formulations which can effectively neutralize microorganisms while maintaining the characteristics of the other formulation matrices.

References have been made to the following literature:

U.S. Pat. No. 4,675,347 relates to an antimicrobial latex composition comprising at least one cationic latex component selected from cationic natural rubber latex and cationic synthetic polymer latex and a cationic antimicrobial agent incorporated in said cationic latex. The resulting composition is antimicrobial latex compositions suitable for use in the manufacture of medical devices and appliances, sanitary products, equipment and furnishings for use in food manufacture and processing.

RU2385333 relates to a substrate body partially molded from natural or synthetic polymer latex having an antimicrobial composition from antimicrobial substance, tightly joined to the first surface of the said substrate, forming a uniform non-volatile antimicrobial coating on at least a region of the said first surface.

U.S. Pat. No. 5,180,585 relates to an antimicrobial composition comprising an inorganic particle with a first coating providing antimicrobial properties and a second coating providing a protective function, method for preparing the same and uses; further processes for producing polymeric articles and a method for controlling microorganisms.

US8067403 relates to systems and methods for the customizable formation of antimicrobial compositions. Further, the disclosure generally relates to systems and methods for preparation of films and coatings using the prepared antimicrobial compositions.

CN100509932 discloses non-silicone vulcanized rubber articles made from at least a majority by weight of ethylene-propylene-diene modified (terpolymer) rubber (such as, without limitation, EPDM and/or NBR) that include silver-based compounds to provide highly desirable long-term antimicrobial characteristics within the cured rubber articles, at least a portion of which exhibits a color other than black, are provided.

It is evident that despite the widespread use of antimicrobial agents, they provide limited protection and have a limited shelf life. Although, a number of antimicrobials are available but, so far there has not been any suggestion for preparation of universal anti microbial additives that can be incorporated into natural rubber lattices, to provide long term protection without affecting the properties of the lattices. Accordingly, there is a need to create stable antimicrobial formulations which may be electrolytically generated in a high concentration within a short duration of time.

The information disclosed in this background of the disclosure section is only for enhancement of understanding of the general background of the invention and should not be taken as an acknowledgement or any form of suggestion that this information forms the prior art already known to a person skilled in the art.

### SUMMARY

The present invention attempts to overcome the problems faced in the prior art, and discloses a non-toxic formulation which can effectively neutralize microorganisms while not altering the characteristics of future lattices by providing for a stabilized antimicrobial composite article.

The present invention relates to an antimicrobial formulation of electrolytically generated metal ions where the specific combination of metal ions in the antimicrobial additive gives it the ability to be effective and work in a broad spectrum against potentially pathogenic bacteria, virus, fungi, mold, mildew and antibiotic resistant species.

In an embodiment the present invention relates to an aqueous antimicrobial formulation for rubber lattices, comprising: an electrolyte 0-10% (w/v); a chelating agent 1-20% (w/v); electrolytically generated transition metal ions 0.1-5% (w/v); in an aqueous electrolytic medium, wherein the pH of the antimicrobial formulation is 7-9.

In another embodiment of the present invention, the electrolyte is selected from a group comprising neutral salts such as inorganic salts of chloride or sulphate or of acids selected from a group of carboxylic acids such as lactic acid or long chain carboxylic acids/fatty acid such as oleic acid and combinations thereof.

In still another embodiment of the present invention, the chelating agent is selected from a group comprising sodium salts of ethylene diamine tetraacetic acid (EDTA), Diethylene Triamine Pentaacetic acid sodium salt (DTPA), 1-Hydroxyethylidene-1,1-diphosphonic acid (HEDP) and Nitrilotriacetic acid (NTA), but not limited to.

In yet another embodiment of the present invention, the transition metal ions is selected from a group comprising silver, copper, zinc, stainless steel and combinations thereof.

In a preferred embodiment of the present invention, the pH adjuster is added to maintain the pH in the range of 7 to 9.

In an embodiment of the present invention, the gas for deoxygenation and air sparging is selected from a group comprising nitrogen, argon or other inert gases.

In an exemplary embodiment of the present invention, the invention relates to a method for preparation of antimicrobial formulation for rubber lattices, comprising the steps: a) weighing 70-90% of the water required in the mixer vessel and deoxygenating it; b) preparing the electrolyte solution by addition of measured amount of electrolyte and chelating agents in the deoxygenated water obtained in step a; c) transferring the electrolyte solution from step b to the electrochemistry vessel, wherein the system comprises, at least one anode and at least one cathode electrode in the electrolyte; wherein the sparging is with gas and potential difference is applied across the electrodes to drive a current, resulting in the generation of the antimicrobial species in the solution.

In another embodiment of the present invention, at least one anode and at least one cathode electrode are selected from a group of transition metals such as silver, copper, stainless steel and combinations thereof, but not limited to.

In a preferred embodiment of the present invention, the electrolyte in the electrolytic medium comprises neutral salts such as inorganic salts of chloride or sulphate or of acids selected from a group of carboxylic acids such as lactic acid or long chain carboxylic acids/fatty acid such as oleic acid and combinations thereof.

In another preferred embodiment of the present invention, the pure ions are electrolytically generated in the aqueous solution of ionic compounds selected from a group of salt of lactic acid or carboxylic acids and chelating agents. Further, the controlled volumes of pressurized air is applied in the electrolytic solution using air sparger to fasten the rate of reaction.

In yet another embodiment of the present invention, the potential difference of 2-30 V is applied on to the electrodes and the reaction is continued for at least 20 minutes-4 hours.

In a preferred embodiment the present invention, the formulation may be in the form of a tablet or capsule containing the antimicrobial powder, or antimicrobial solutions in the form as aerosols, infusions, sprays, mist, drops, or one or more liquid formulations or spray dried to generate a powdered form, and combinations thereof.

The foregoing summary is illustrative only and is not intended to be in any way limiting. In addition to the illustrative aspects, embodiments, and features described above, further aspects, embodiments, and features will become apparent by reference to the drawings and the following detailed description.

### DETAILED DESCRIPTION

While the embodiments of the disclosure are subject to various modifications and alternative forms, specific embodiments thereof have been shown by way of example in the figures and will be described below. It should be understood, however, that it is not intended to limit the disclosure to the particular forms disclosed, but on the contrary, the disclosure is intended to cover all modifications, equivalents, and alternatives falling within the scope of the disclosure. Further, the phraseology and terminology employed in the description is for the purpose of description only and not for the purpose of limitation.

The terms “comprises”, “comprising”, or any other variations thereof used in the disclosure, are intended to cover a non-exclusive inclusion, such that a device, apparatus, system, assembly, method that comprises a list of components or a series of steps that does not include only those components or steps but may include other components or steps not expressly listed or inherent to such apparatus, or assembly, or device. In other words, one or more elements or steps in a system or device or process proceeded by “comprises . . . a” or “comprising . . . of” does not, without more constraints, preclude the existence of other elements or additional elements or additional steps in the system or device or process as the case may be.

The present invention relates to antimicrobial formulations of electrolytically generated metal ions and chelating agents and method of preparing the same. The said formulation is in the form of a stabilized ionic antimicrobial agent wherein the specific combination of transition metal ions with the chelating agents provides the ability of being extremely broad spectrum, which can work against potentially pathogenic bacteria, virus, fungi, mold, mildew and antibiotic resistant species.

In accordance with the embodiment of the present invention, the invention relates to an aqueous antimicrobial formulation for rubber lattices, comprising: an electrolyte 0-10% (w/v); a chelating agent 1-20% (w/v); electrolytically generated transition metal ions 0.1-5% (w/v); in an aqueous electrolytic medium, wherein the pH of the antimicrobial formulation is 7-9. The neutral electrolytes are added to increase the metal uptake in the composition. Besides, the formulations being the water-based solutions, chelating agents are added in the said concentration to stably hold the metals in the formulation. The neutral pH of the formulation is maintained so as not to disturb the rubber bath in the process.

In an embodiment of the present invention, the electrolyte is selected from a group comprising neutral salts such as inorganic salts of chloride or sulphate or of acids selected from a group of carboxylic acids such as lactic acid or long chain carboxylic acids/fatty acid such as oleic acid and combinations thereof.

In another embodiment of the present invention, the chelating agent is selected from a group comprising sodium salts of ethylene diamine tetraacetic acid (EDTA), Diethylene Triamine Pentaacetic acid sodium salt (DTPA), 1-Hydroxyethylidene-1,1-diphosphonic acid (HEDP) and Nitrilotriacetic acid (NTA), but not limited to.

In yet another embodiment of the present invention, the transition metal ions is selected from a group comprising silver, copper, zinc, stainless steel and combinations thereof.

In a preferred embodiment of the present invention, the pH adjuster is added to maintain the pH in the range of 7 to 9.

In an embodiment of the present invention, the gas for deoxygenation and air sparging is selected from a group comprising nitrogen, argon or other inert gases.

In an exemplary embodiment of the present invention, the invention relates to a method for preparation of antimicrobial formulation for rubber lattices, comprising the steps: a) weighing 70-90% of the water required in the mixer vessel and deoxygenating it; b) preparing the electrolyte solution by addition of measured amount of electrolyte and chelating agents in the deoxygenated water obtained in step a; c) transferring the electrolyte solution from step b to the electrochemistry vessel, wherein the system comprises, at least one anode and at least one cathode electrode in the electrolyte; d) applying potential difference across the electrodes to drive a current, resulting in the generation of the antimicrobial species in the electrolyte solution, wherein the sparging is applied with air spargers to fasten the rate of reaction.

In another embodiment of the present invention, at least one anode and at least one cathode electrode are selected from a group of transition metals such as silver, copper, stainless steel and combinations thereof, but not limited to.

In a preferred embodiment of the present invention, the electrolyte in the electrolytic medium comprises neutral salts such as inorganic salts of chloride or sulphate or of acids selected from a group of carboxylic acids such as lactic acid or long chain carboxylic acids/fatty acid such as oleic acid and combinations thereof.

In another preferred embodiment of the present invention, the pure ions are electrolytically generated in the aqueous solution of ionic compounds selected from a group of salt of lactic acid or carboxylic acids and chelating agents. Further, the controlled volumes of pressurized air is applied in the electrolytic solution using air sparger to fasten the rate of reaction.

In yet another embodiment of the present invention, the potential difference of 2-30 V is applied on to the electrodes and the reaction is continued for at least 20 minutes-4 hours.

In a preferred embodiment the present invention, the formulation may be in the form of a tablet or capsule containing the antimicrobial powder, or antimicrobial solutions in the form as aerosols, infusions, sprays, mist, drops, or one or more liquid formulations or spray dried to generate a powdered form, and combinations thereof.

### EXAMPLES

Example 1: Electrochemical setup for the generation of ions: Atypical electrolysis process of the present invention entails the steps of using neutral salts, diethylene triamine pentaacetic acid sodium salt and also of carboxylic acids selected from a group of lactic acid, long chain carboxylic acids/fatty acids as an electrolytic solution and transition metal selected from a group of zinc, copper and silver metals as electrodes. The chelating agent is added into the electrolytic media to complex the metal ions that are released from the anode. The said electrodes (especially anode) are preferably formed from 99.99 percent pure metal having impurities lesser than 100 ppm. The anode is spaced apart from the cathode at a distance of around 0.1 mm-100 cm. An electric potential of 2-20 V was applied on to the electrodes. An air sparger having a hollow metal ring with a hose coupled thereto is introduced into the solution for introducing controlled amount of pressurized gas in the form of air bubbles. When direct current is applied onto the electrodes, metal ions were generated which react with the electrolytic solution to form metal complexes. The sparging procedure by breaking the diffusion layer around the electrodes, improves the reaction rate. Generation of a desired concentration of ions is also possible by application of specific voltage for a fixed duration of time.

Example 2: Microbiological studies: ASTM D7907 test was done to study the antibacterial activity of the material tested against Staphylococcus aureus and Ps. aeruginosa in actual glove samples that were made following the typical manufacturing processes. The additive was added in the compounded rubber bath at the dilution of 3% by weight.

The absorption method was used for the determination of antibacterial activity of gloves to ASTM D7907 against Staphylococcus aureus and Ps. aeruginosa. The test sample (10 cm2) was inoculated with 20 μl of the relevant culture containing a known number of organisms (1×106 cfu/ml) in phosphate buffered solution covered with coverslip. The product was tested in triplicate against each organism. The control material (without antimicrobial activity) was also inoculated and the three test samples were sampled immediately and 3 samples were incubated for 30 min. After incubation the samples were transferred to 50 ml of sterile conical centrifuge tube containing 10 ml of neutralizer solution. The solution was vortexed for 15 seconds and the extracts were serially diluted and the bacteria enumerated using pour plate method with Tryptone Soya Agar (TSA). The plates were incubated at 37±20° C. for 40-48 hrs and any resultant colonies counted. The Neutralizer was validated. The results have been represented in Table 1 (for Staphylococcus aureus) and Table 2 (for Ps. aeruginosa).

TABLE 1
ASTM D7907 results for the test samples treated against

| | Staphylococcus aureus ATCC 6538P | |
|---|---|---|
| | | Treated Sample |
| Sample No. | Positive Control | T = 30 min. |
| 1 (cfu/ml) | 7.9 × 10⁶ | 9.2 × 10² |
| 2 (cfu/ml) | 7.2 × 10⁶ | 9.5 × 10² |
| 3 (cfu/ml) | 7.4 × 10⁶ | 9.8 × 10² |
| Mean (cfu/ml) | 7.5 × 10⁶ | 9.5 × 10² |
| Antibacterial Activity | — | 99.98% |
| (% reduction) | | |

Note: Initial inoculum was 20 μl of 7.5×106 cfu/ml

From the above observation results it was concluded that the submitted test specimen (glove) showed 99.98% against Staphylococcus aureus as per ASTM D7907

TABLE 2
ASTM D7907 results for the test samples treated
against Ps. aeruginosa

| | Ps. Aeruginosa | |
|---|---|---|
| | | Treated Sample |
| Sample No. | Positive Control | T = 30 min. |
| 1 (cfu/ml) | 2.6 × 10⁶ | 9.8 × 10³ |
| 2 (cfu/ml) | 2.1 × 10⁶ | 9.1 × 10³ |
| 3 (cfu/ml) | 3.4 × 10⁶ | 9.4 × 10³ |
| Mean (cfu/ml) | 2.7 × 10⁶ | 9.4 × 10³ |
| Antibacterial Activity | — | 99.65% |
| (% reduction) | | |

Note: Initial inoculum was 20 μl of 3.0×106 cfu/ml

From the above observation results it was concluded that the submitted test specimen (Glove) showed 99.65% against Ps. aeruginosa as per ASTM D7907

Example 3: Antimicrobial formulations comprising the electrolytic generation of silver ions in the lactic acid electrolytic media, resulted in the release of ˜ 841 ppm silver ions (Table 3) and a promising zone of inhibition was observed with S. aureus

TABLE 3
Table showing the antimicrobial formulations with organic acid.

| | | | | | Sunlight and |
|---|---|---|---|---|---|
| | | Anode/cathode | | | thermal |
| Batch, pg # | chemical | and time | Titration | Zone (in mm) | stabiliy |
| 20210724#4 | 50 mL | silver anode | After half | (S. aureus) at | The solution |
| | lactic acid | and SS | hr = | ~200% | is thermally |
| | in 500 | cathode, 1 hr | 8.5 mL | higher | stable and |
| | mL water | | (917.2 | concentration | quite stable |
| | pH = 1 | | ppm) | made by | with sunlight |
| | | | and after | heating to | |
| | | | 1 hr = | 50% | |
| | | | 7.8 mL | volume = | |
| | | | (841.6 ppm) | 27.04 mm | |

In the electrochemical synthesis process often times the dissolution from the anode and the deposition on the cathode can go on simultaneously and in the above example probably half an hour was enough to get a good quantity of the stable metal ions in the formulation and increasing it to an hour did not help. The short time required to prepare the formulation makes it very production worthy.

The above solution was concentrated to 50% of its volume by gentle heating (50 to 60° C.) and the amount of silver nearly doubled and the S. aureus zone was measured to be 27.04 mm which confirmed the formulation's good antimicrobial activity.

Example 4: Further, the chelating agents DTA and EDTA were mixed together and the stability and antimicrobial potency of the formulation was checked. Next, using a lower quantity of EDTA mixed with the DTPA yielded the best results, 15 mL DTPA+7.5 g EDTA in 500 mL water (Table 4).

TABLE 4
Anti microbial Formulation comprising Diethylene
TriaminePentaacetic acid sodium salt (DTPA) and EDTA

| | | | | | Sunlight and |
|---|---|---|---|---|---|
| | | Anode/cathode | | | thermal |
| Batch, pg # | Chemical | and time | Titration | Observation | stability |
| 20210724#1 | 15 mL | silver anode | After | yellow | Stable with |
| | DTPA in | and SS | half hr = | solution | sunlight |
| | 500 mL | cathode, 1 hr | 10 mL | | |
| | water | | (1079 | | |
| | pH = 12, | | ppm) | | |
| | | | and after | | |
| | | | 1 hr = | | |
| | | | 14.5 mL | | |
| | | | (1564 | | |
| | | | ppm) | | |
| 20210724#3 | 15 mL | silver anode | After | Wine-red | The solution |
| | DTA + 15 g | and SS | half hr = | solution | is thermally |
| | EDTA in | cathode, 1 hr | 14 mL | | unstable, |
| | 500 mL | | (1510 | | heated at 80 |
| | water | | ppm) | | C for 30 |
| | pH = 8, | | and after | | min. Stable |
| | | | 1 hr = 23 | | with |
| | | | mL | | sunlight |
| | | | (2481 | | The solution |
| | | | ppm) | | is thermally |
| | | | | | stable. |
| 20210726#1 | 15 mL | silver anode | After | Yellow | Stable with |
| | DTPA + 7.5 | and SS | half hr = | solution. | sunlight as |
| | g EDTA in | cathode, 1 hr | 8.5 mL | (S. aureus) at | well |
| | 500 mL | | (917 | ~200% | |
| | water | | ppm) | higher | |
| | pH = 8, | | and after | concentration | |
| | | | 1 hr = | made by | |
| | | | 12.5 mL | heating to | |
| | | | (1348 | 50% volume = | |
| | | | ppm) | 26.44 mm | |
| 20210623#2 | 30 g EDTA + | Silver anode | 16.8 mL | Light yellow | The solution |
| | 4 g NaOH | and SS | (1812 | solution | is clear in |
| | in 500 mL | cathode, 2 hr | ppm). | (S. aureus) at | colour, |
| | water | SS had a bright | Expected | as-is | slight yellow |
| | pH = 8 | deposit of | in 1 hr | concentration = | tinge. Stable |
| | | silver | ~900 ppm) | 19.26 mm | with |
| | | | | and P. | sunlight |
| | | | | Aeruginosa = | |
| | | | | 19.26 mm | |

The 20210726 #1 solution was gently heated at around 50-60° C. and the volume was made to about −5%. The resultant solution was very high in silver ˜2859 ppm whose titration yielded 26.5 ml as the reading and the zone with S. aureus came out at a promising 26.44 mm.

Example 5: Further, the copper EDTA complexes were formed electrochemically. The resultant solutions were bright blue in color and highly stable, which could be very useful as additives for imparting distinguished blue color to the formulations where the additional color additives are not required (Table 5).

TABLE 5
Anti microbial Formulation comprising the copper electrode
with chelating agents

| | | | | | Sunlight |
|---|---|---|---|---|---|
| | | Anode/ | | | and |
| | | cathode | | Zone | thermal |
| Batch, pg # | Chemical | and time | Titration | (in mm) | stabiliy |
| 20210624#1 | 30 g EDTA + | copper anode | 687 ppm | (S. | The |
| | 4 g NaOH | and SS | of Cu | aureus) | solution is |
| | in 500 ml | cathode, 1.5 hr | | | bright blue |
| | water | SS had a bright | | | in colour. |
| | pH = 8 | deposit of | | | Stable with |
| | | copper | | | sunlight |

Example 6: To study the sustainability of the potency of the formulations, the anti-microbial activity of the rubber items was studied over a period of 15 months. For this, the antimicrobial activity of the material against the E. coli micro organism was studied after 15 months of the article manufacture and it was observed that the article retained approx. 80.90% of anti microbial activity even after 15 months (Initial inoculum was 0.2 ml of 4.8×105 cfu/ml).

TABLE 6
Results

| | E. coli ATCC 25299 | |
|---|---|---|
| Sample No. | Sample at 0 hrs | Sample after 2 hrs |
| Mean (cfu/ml) | 2.2 × 10⁵ | 4.2 × 10⁴ |
| Log reduction | — | 0.71 |
| Antibacterial | — | 80.90% |
| Activity | | |

Example 6: To study the leaching, the gloves were treated with 100 C water for one hour and the leachate was studied by AAS. The leachate was only having a trace of the active component proving that the antimicrobial additive is stable in the glove (Table 7)

TABLE 7

| | Glove leachate |
|---|---|
| | after 100° C. |
| | treatment after 1 hr |
| Analysis after AAS treatment | 0.1 ppm |

Some of the most common rubber manufacturing processes are extrusion, latex dipping, molding, and calendering. Each one may have some advantages, for example extrusion manufacturing can produce products in high volumes at a lower production cost. The last most common manufacturing process is called calendaring, which is used to produce sheets or films of rubber. Each manufacturing process is ideal for producing certain types of rubber products. The anti microbial formulations in the present invention can work for several different rubber manufacturing processes. It is to be added as last component to either the coagulant, the rubber melt and or the polymer bath. It is single component formulation and does not require any binder. The additives are versatile enough for application into all these manufacturing processes without altering the characteristics of the articles. In accordance with advantages of the present invention as compared with the existing formulations, the present invention is to provide a big change in the latex industry. These electrolytic formulations having free silver and other metal ions, thus, can kill bacteria, viruses and fungus that evolve in the formulations, on contact due to the antimicrobial properties of silver and copper ions along with organic acids, DTPA and EDTA and other aqueous based formulations. These antimicrobial latex compositions retain good stability over a long period of storage and also prevent metal leaching to occur out of the rubber items during usage (confirmed by AAS) and the dosage (depending on the usage): 0.1 to 5%.

Technical Advantages: The resulting formulations are effective at low doses (1-4%) yielding promising results in tests such as the ASTM D-7907; Compatible with the rubber manufacturing process, skin-safe, stable and broad-spectrum; The unique synthetic process yields a formulation having the desired properties; There are no fumes and the formulation is non-ionic and the pH near neutral; It enables the rubber products which are generally prone to microbial contamination to be stored and used in sterile like conditions; This additive is an enabler for the health-care industry.

It will be further appreciated that functions or structures of a plurality of components or steps may be combined into a single component or step, or the functions or structures of one-step or component may be split among plural steps or components. The present invention contemplates all of these combinations. Unless stated otherwise, dimensions and geometries of the various structures depicted herein are not intended to be restrictive of the invention, and other dimensions or geometries are possible. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention. The present invention also encompasses intermediate and end products resulting from the practice of the methods herein. The use of “comprising” or “including” also contemplates embodiments that “consist essentially of” or “consist of” the recited feature.

Although embodiments for the present invention have been described in language specific to structural features, it is to be understood that the present invention is not necessarily limited to the specific features described. Rather, the specific features and methods are disclosed as embodiments for the present invention. Numerous modifications and adaptations of the system/component of the present invention will be apparent to those skilled in the art, and thus it is intended by the appended claims to cover all such modifications and adaptations which fall within the scope of the present invention.

1. An aqueous antimicrobial formulation for rubber lattices, the formulation comprising:
an aqueous electrolytic medium containing an electrolyte, wherein the electrolyte is up to 10 percent weight per volume of the formulation (% w/v);
a chelating agent 1-20% w/v; and
electrolytically-generated transition metal ions 0.1-5% w/v, wherein the pH of the formulation is 7-9.

2. The formulation of claim 1, wherein the electrolyte contains a neutral salt.

3. The formulation of claim 2, wherein the neutral salt is at least one of, a chloride salt, a sulphate salt, a lactic acid salt, a long chain carboxylic acid salt, and an oleic acid salt.

4. The formulation of claim 1, wherein the chelating agent is at least one of, sodium salts of ethylene diamine tetraacetic acid (EDTA), Diethylene Triamine Pentaacetic acid sodium salt (DTPA), 1-Hydroxyethylidene-1,1-diphosphonic acid (HEDP), and Nitrilotriacetic acid (NTA).

5. The formulation of claim 1, wherein the transition metal ions are at least one of silver, copper, zinc, and stainless steel.

6. The formulation of claim 1, further comprising:
a pH adjuster to maintain the pH in the range of 7 to 9.

7. A method of preparation of an antimicrobial formulation for rubber lattices, the method comprising:
deoxygenating water, wherein the water is 70-90 percent weight per volume of the formulation (% w/v);
adding electrolyte and chelating agents to the deoxygenated water to obtain an electrolyte solution;
applying a potential difference across an anode and a cathode immersed in the electrolyte solution to drive a current and generation an antimicrobial species in the electrolyte solution; and
sparging the electrolyte solution during the applying to increase a rate of reaction.

8. The method of claim 7, wherein the anode and the cathode contain at least one of silver, copper, zinc, and stainless steel.

9. The method of claim 7, wherein the electrolyte contains a neutral salt.

10. The method of claim 9, wherein the neutral salt is at least one of, a chloride salt, a sulphate salt, a lactic acid salt, a long chain carboxylic acid salt, and an oleic acid salt.

11. The method of claim 7, wherein the chelating agent is at least one of, sodium salts of ethylene diamine tetraacetic acid (EDTA), Diethylene Triamine Pentaacetic acid sodium salt (DTPA), 1-Hydroxyethylidene-1,1-diphosphonic acid (HEDP), and Nitrilotriacetic acid (NTA).

12. The method of claim 7, wherein the sparging uses controlled volumes of pressurized air from air spargers.

13. The method of claim 7, wherein the deoxygenating and air sparging use an inert gas.

14. The method of claim 7, wherein the applying applies a potential difference of 2-30 V for 20 minutes-4 hours.

15. The method of claim 7, further comprising:
forming the formulation into a tablet or capsule containing an antimicrobial powder, or an antimicrobial solution as an aerosol, infusion, spray, mist, drop, or spray-dried powder.
